(19) United States
(12) Patent Application Publication
(10) Pub. No.: US 2008/0081623 A1
(43) Pub. Date: Apr. 3, 2008

(54) PRIORITY HANDOFF BASED ON BATTERY CHARGE LEVEL

(75) Inventors: John M. Burgan, North Palm Beach, FL (US); William E. Ceres, Palm Beach Gardens, FL (US); Donald R. Dale, West Palm Beach, FL (US); Joseph Patino, Pembroke Pines, FL (US); Marco Pulido, Miramar, FL (US); Russell L. Simpson, Miami, FL (US)

Correspondence Address: CUENOT & FORSYTHE, L.L.C., 12230 FOREST HILL BLVD., SUITE 120, WELLINGTON, FL, 33414, US

(73) Assignee: MOTOROLA, INC., Schaumburg, IL (US)

(21) Appl. No.: 11/536,939

(22) Filed: Sep. 29, 2006

(51) Int. Cl. H04Q 7/20

(52) U.S. Cl. 455/436

(57) ABSTRACT

A method (400) for allocating handoff of mobile stations (105, 110) to a first network node (115). The method can include receiving a handoff request for a first mobile station. Handoff of the first mobile station can be granted in response to determining that the first mobile station has an effective level of battery charge equal to or below a threshold value. Handoff of the first mobile station can be denied in response to determining that the first mobile station has an effective level of battery charge greater than the threshold value. The method also can include receiving status information (130) communicated by the first mobile station. The status information can indicate an effective battery level of the first mobile station. In another arrangement, the status information can indicate a handoff priority level of the first mobile station.

### BACKGROUND OF THE INVENTION

1. Field of the Invention

The present invention generally relates to mobile communications and, more particularly, to mobile station handoff.

2. Background of the Invention

Mobile stations oftentimes communicate via cellular communications networks. A cellular communications network is an RF communications network comprising a number of communication cells (hereinafter “cells”), each of which is served by a transceiver, such as a base transceiver station or a repeater. The cells usually are geographically distributed in a tile-like manner in order to provide radio coverage over a wide area. When a mobile station moves from one cell into another, communication services for that mobile station usually are transferred, or handed off, from the transceiver in the first cell to the transceiver in the second cell. In order to prevent communication sessions from being dropped as the mobile station moves between cells, the cells usually are configured so that there is a certain amount of overlap between them. In the area of overlap, either of the transceivers can communicate with the mobile station. Sometimes more distant transceivers also are within communication range of the mobile station.

Because the proximity of a mobile station to a transceiver may vary, most cellular protocols control the transmit power of the mobile station. When the mobile station is close to the transceiver with which it is communicating, it is typically instructed to transmit at low power. Conversely, when the mobile station is at the fringe of the transceivers coverage area, it is typically instructed to increase its transmit power. Unfortunately, increasing the transmit power of a mobile station also increases the mobile station's battery drain. Once the handoff to a new transceiver has taken place, however, the mobile station typically will receive new instructions on how to adjust its transmit power.

Ideally, all mobile stations registered on a cellular communications network would be assigned to the transceiver that can best receive their signal. Accordingly, all mobile stations would be able to transmit using the minimum amount of power that is required to maintain a call or data link. Unfortunately, this is not always practical in real world conditions. As more mobile stations enter a particular cell, the cell's capacity to support mobile station communication sessions may be reached. In such circumstances, it may not be possible for a transceiver in that (second) cell to accept a handoff of a mobile station entering the cell from another (first) cell. Thus, the mobile station may be required to continue transmitting to the transceiver servicing the first cell, which may be located further from the mobile station than the second cell's transceiver. In that case, the mobile station may be required to transmit at higher power than would be necessary had the handoff to the second cell taken place. If the mobile station has a low battery charge, maintaining high transmit power can be problematic.

### SUMMARY OF THE INVENTION

The present invention relates to a method for allocating handoff of mobile stations to a first network node. The method can include receiving a handoff request for a first mobile station. Handoff of the first mobile station can be granted in response to determining that the first mobile station has an effective level of battery charge equal to or below a threshold value. Handoff of the first mobile station can be denied in response to determining that the first mobile station has an effective level of battery charge greater than the threshold value. The method also can include receiving status information communicated by the first mobile station. The status information can indicate an effective battery level of the first mobile station. In another arrangement, the status information can indicate a handoff priority level of the first mobile station. The method further can include determining that the first network node is at or near peak capacity.

The method also can include receiving status information communicated by a second mobile station. The status information can indicate an effective battery level of the second mobile station. In another arrangement, the status information can indicate a handoff priority level of the second mobile station. Handoff of the second mobile station can be denied in response to the second mobile station having an effective level of battery charge greater than the threshold value. In another arrangement, the second mobile station can be handed off to a second network node in response to the second mobile station having an effective level of battery charge greater than the threshold value.

The present invention also relates to a mobile station that includes a transceiver, a battery, a battery charge monitor and a controller. The controller can receive a signal from the battery charge monitor that indicates an effective charge level of the battery, process the signal to generate status information, and communicate the status information to the transceiver. The status information can include a handoff priority level for the mobile station. The transceiver can transmit the status information to a node of a communications network.

Another embodiment of the present invention can include a machine readable storage being programmed to cause a machine to perform the various steps described herein.

### BRIEF DESCRIPTION OF THE DRAWINGS

Preferred embodiments of the present invention will be described below in more detail, with reference to the accompanying drawings, in which:

FIG. 1 depicts a communications system that is useful for understanding the present invention;

FIG. 2 depicts a block diagram of a network node that is useful for understanding the present invention; and

FIG. 3 depicts a block diagram of a mobile station that is useful for understanding the present invention; and

FIG. 4 is a flowchart that is useful for understanding the present invention.

### DETAILED DESCRIPTION

While the specification concludes with claims defining features of the invention that are regarded as novel, it is believed that the invention will be better understood from a consideration of the description in conjunction with the drawings. As required, detailed embodiments of the present invention are disclosed herein; however, it is to be understood that the disclosed embodiments are merely exemplary of the invention, which can be embodied in various forms. Therefore, specific structural and functional details disclosed herein are not to be interpreted as limiting, but merely as a basis for the claims and as a representative basis for teaching one skilled in the art to variously employ the present invention in virtually any appropriately detailed structure. Further, the terms and phrases used herein are not intended to be limiting but rather to provide an understandable description of the invention.

The present invention relates to a method for allocating handoff of mobile stations to a network node. In particular, when a network node is heavily loaded and it is desired to limit the number of communication sessions established on the network node, handoff priority can be given to mobile stations which have effectively low levels of remaining battery charge. Accordingly, battery drain can be minimized for those mobile stations. Mobile stations which have a relatively high level of remaining battery charge can be directed to maintain their present network communication links or can be redirected to other network nodes that may be located farther away. Such mobile stations may be required to transmit at a higher power level than would otherwise be necessary if the requested handoff were granted, but likely can tolerate a greater amount of battery drain since they have a higher level of effective battery charge remaining.

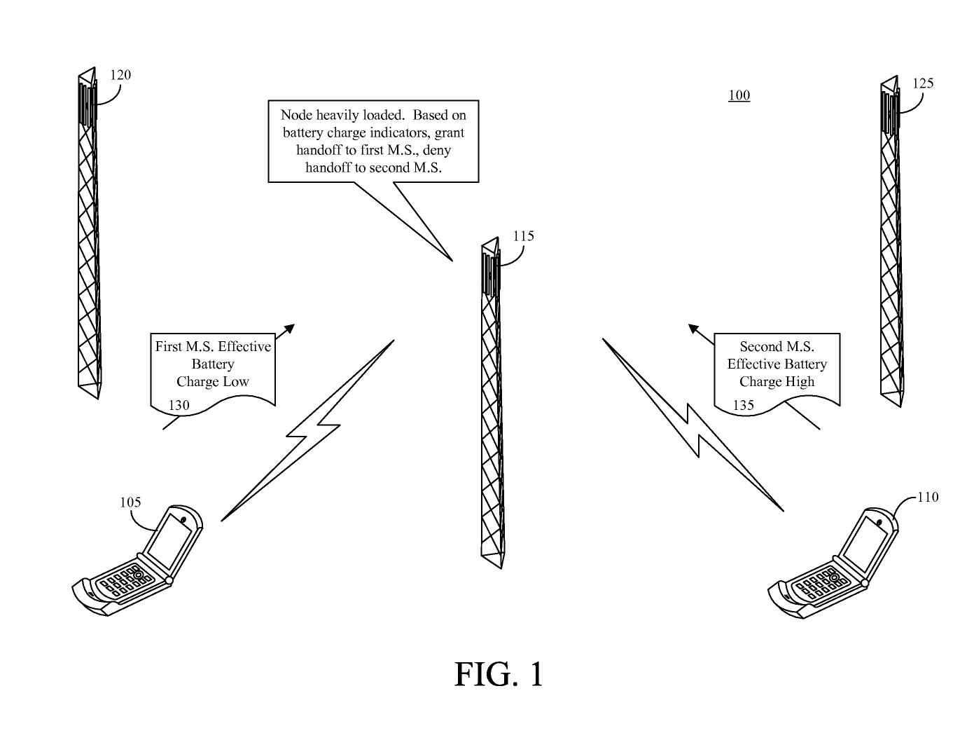

FIG. 1 depicts a communications system 100 that is useful for understanding the present invention. The communications system 100 can include one or more mobile stations 105, 110. The mobile stations 105, 110 can be mobile telephones, mobile radios, personal digital assistants, computers having wireless communication adapters, wireless gaming consoles, or any other devices that may wirelessly communicate with a communications network. The communications system also can include a plurality of network nodes 115, 120, 125 of a communications network. The network nodes 115, 120, 125 can be base transceiver stations, repeaters, access points, or any other network components that may wirelessly communicate with the mobile stations 105, 110. In addition to the network nodes 115, 120, 125, the communications system 100 also can include other network nodes that are not shown. For example, the communications system can comprise a mobile switching center (MSC), a basestation controller (BSC), a server, or any other suitable communications network component(s).

In operation, when a request is received for a handoff of the mobile station 105 to the network node 115, status information 130 also can be communicated. Similarly, when a request is received for a handoff of the mobile station 110 to the network node 115, status information 135 can be communicated. The status information 130, 135 can be processed to determine a handoff priority for each of the respective mobile stations 105, 110. Based on the handoff priorities, decisions can be made whether to grant the requested handoffs.

For example, assume that the network node 115 is heavily loaded. If the status information 130 indicates that the effective battery level of the mobile station 105 is low and the status information 135 indicates that the effective battery level of the mobile station 110 is high, handoff of the mobile station 105 can be granted while handoff of the mobile station 110 is denied. In one arrangement, if the mobile station 110 already has established a communication session on the network node 115, the network node 115 can initiate handoff of the mobile station 110 to the network node 125 in order to free up resources on the network node 115 which may be allocated to support a communication session for the communication device 105.

An effectively low level of battery charge can be a level of charge below a threshold value. The threshold value can be, for example, a level of charge that is less than 10%, 20% or 30% of a battery's fully charged level. In another arrangement, the threshold value can vary depending on the level of loading on the network node 115. For instance, the threshold value can decrease as the loading on the network node increases, and the threshold value can increase as the loading on the network node decreases.

In yet another arrangement, the threshold value can be determined by evaluating the effective battery levels of a plurality of mobile stations 105, 110 requesting handoff to the network node 115 and/or a plurality of mobile stations which have communication sessions established on the network node 115. For example, if the network node 115 can support twenty communication sessions, and twenty five mobile stations 105, 110 have either requested handoff to the network node 115 or already have established communication sessions on the network node 115, the threshold value can be selected by identifying a value for which the level of battery charge for five of the mobile stations 105, 110 will fall above the threshold value, and the battery charge for twenty of the mobile stations 105, 110 will fall at or below the threshold value. Handoff requests can be denied for the mobile stations 110 having effective levels of battery charge above the threshold value. Further, any mobile stations 110 already having communication sessions established with the network node 115 and which have effective levels of battery charge above the threshold value can be handed off to other network nodes 120, 125.

In an arrangement in which the status information 130, 135 indicates handoff priorities, the handoff priorities can be processed in a similar manner to determine to which mobile stations 105, 110 to grant handoff to the network node 115. However, those mobile stations 105 with a handoff priority higher than or equal to the threshold value can be granted handoff to the network node 115. Mobile stations 110 having a handoff priority level below the threshold value can be denied handoff or, in the case such mobile stations 110 already have communication sessions established with the network node 115, handoff to other network nodes 120, 125 can be initiated for such mobile stations 110.

In one arrangement, an effective battery level can be determined by an amount of charge remaining on a mobile station's battery. For instance, the voltage of the mobile station's battery can be measured. In another arrangement, the effective battery level can be determined by monitoring an amount of power transferred from the mobile station's battery since the last battery re-charge. In yet another arrangement, the effective battery level can be determined by monitoring an amount of transmit power used since the last battery re-charge, and subtracting the transmit power used from a total available transmit power, which may be estimated based on a full battery charge. The transmit power used can be estimated by monitoring the amount of time a mobile station 105 has spent transmitting, and at what transmit power. Still, the effective battery level can be measured in any other suitable manner and the invention is not limited in this regard.

In one arrangement, the status information 130, 135 can include indicators that indicate an effective battery level remaining on the respective mobile stations 105, 110, in which case the network infrastructure can determine the level of handoff priority to assign to the mobile stations 105, 110. In another arrangement, the status information 130, 135 can include handoff priority levels generated by the respective mobile stations 105, 110. The handoff priority levels can inversely correlate to the effective levels of battery charge on the mobile stations, in which case the network infrastructure need not be tasked with determining the handoff priority levels, but merely process priority information received from the mobile stations 105, 110. In this arrangement, each of the mobile stations 105, 110 can include an algorithm and/or a lookup table to generate their respective handoff priority level based on the levels of charge remaining on their batteries. Such handoff priority levels can be processed to determine whether to allow or deny handoff to the mobile stations 105, 110, or to request handoff of the mobile stations 105, 110 from the network node 115 to another network node 120, 125.

The status information 130, 135 can be communicated in response to a request from the network node 115, or automatically sent by the mobile stations 105, 110. For example, in a system that implements mobile-controlled handoff (MCHO), the mobile stations 105, 110 can communicate the status information 130, 135 when handoff requests are generated. In an alternate arrangement, the network node 115 can request the status information 130, 135 only if the network node 115 is heavily loaded when the handoff requests are received. The mobile stations 105, 110 can communicate the status information 130, 135 in response to such requests.

In a system that implements network controlled handoff (NCHO), a network node that comprises network infrastructure which monitors the signals of the mobile stations 105, 110 can request the status information 130, 135. Such a network node can include, for instance, any of the network nodes 115, 120, 125, an MSC, a BSC, a server, or any other suitable network component(s). The network infrastructure then can process the status information 130, 135 and determine whether handoff of the mobile station 105 and/or handoff of the mobile station 110 to the network node 115 should be granted, forward the status information 130, 135 to the network node 115 for processing, or forward the status information 130, 135 to another component of the communications system 100 configured to process such information 130, 135.

In a system that implements mobile assisted handoff (MAHO), the network infrastructure typically will direct the mobile stations 105, 110 to measure signals of surrounding network nodes, and report those measurements back to the network infrastructure. The status information 130, 135 can be reported to the network infrastructure when the signal measurements are reported, prior to the signal measurements being reported, or after the signal measurements are reported. In one arrangement, the status information 130, 135 can be reported only in circumstances when a mobile station's effective battery charge is low.

At this point it should be noted that the methods described herein for reporting the status information 130, 135 are merely examples of reporting processes that can be implemented, and the invention is not limited in this regard. In particular, any suitable method or methods can be used to report the status information 130, 135 in a manner that enables such information 130, 135 to be processed when determining whether to allow handoff of a mobile station to a network node, and such method or methods are within the scope of the present invention.

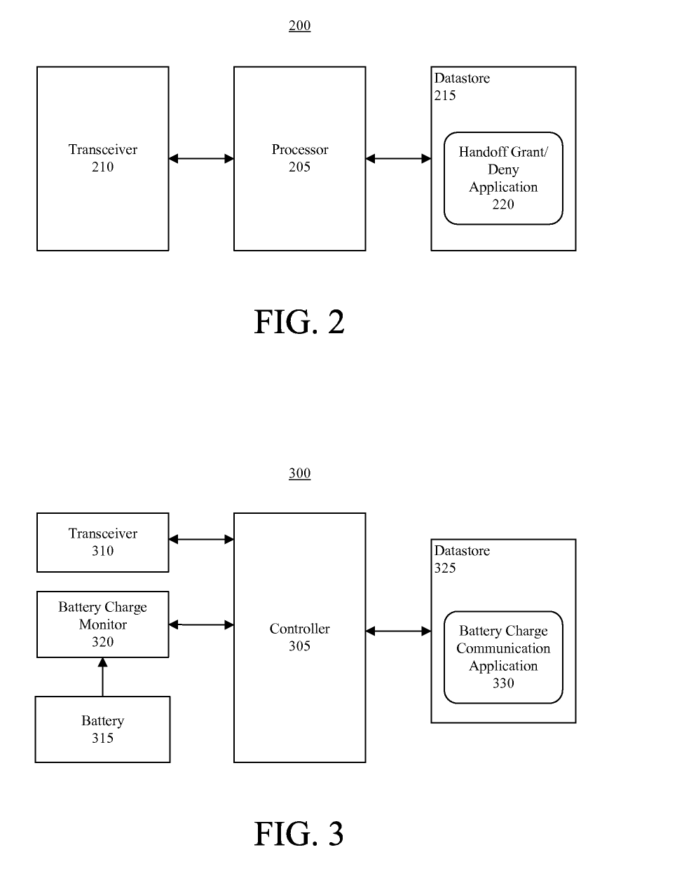

FIG. 2 depicts a block diagram of a network node 200 that is useful for understanding the present invention. The network node 200 can be a base transceiver station, a repeater, an MSC, a BSC, a server, or any other component of the communications network suitable for processing requests and generating correlating responses. The network node 200 can include a processor 205. The processor 205 can comprise, for example, a central processing unit (CPU), a digital signal processor (DSP), an application specific integrated circuit (ASIC), a programmable logic device (PLD), a plurality of discrete components that cooperate to process data, and/or any other suitable processing device.

The network node 200 can be communicatively linked to a transceiver 210 that is used by the network node 200 to communicate with a plurality of mobile stations. The transceiver 210 can be a component of the network node. However, in the case that the network node 200 that does not include its own transceiver (e.g. an MSC, a BSC or a server), the transceiver 210 can be a component of another network node, such as a base transceiver station or a repeater, that is communicatively linked to the network node 200. The transceiver 210 can communicate data via IEEE 802 wireless communications, including 802.11 and 802.16 (WiMax), WPA, WPA2, GSM, TDMA, CDMA, WCDMA, direct wireless communication, TCP/IP, or any other suitable form of wireless communications.

The network node 200 can include a datastore 215. The datastore 215 can include one or more storage devices, each of which can include a magnetic storage medium, an electronic storage medium, an optical storage medium, a magneto-optical storage medium, and/or any other storage medium suitable for storing digital information. In one arrangement, the datastore 215 can be integrated into the processor 205.

A handoff grant/deny application 220 can be contained on the datastore 215. The handoff grant/deny application 220 can be executed by the processor 205 to implement the methods and processes described herein. For example, while executing the handoff grant/deny application 220, the processor can process status information received from the mobile stations to determine whether to grant or deny handoff to the network node 200, or another network node controlled by the network node 200.

FIG. 3 depicts a block diagram of a mobile station 300 that is useful for understanding the present invention. The mobile station 300 can include a controller 305. The controller 305 can comprise, for example, a CPU, a DSP, an ASIC, a PLD, a plurality of discrete components that cooperate to process data, and/or any other suitable processing device.

The mobile station 300 also can include a transceiver 310 that is used by the mobile station 300 to communicate with network nodes of the communications network. The transceiver 310 can communicate data via IEEE 802 wireless communications, including 802.11 and 802.16 (WiMax), WPA, WPA2, GSM, TDMA, CDMA, WCDMA, direct wireless communication, TCP/IP, or any other suitable form of wireless communications.

The mobile station further can include a battery 315 and a battery charge monitor 320. The battery charge monitor 320 can monitor the effective charge level of the battery 315. For example, the battery charge monitor 320 can measure the voltage of the battery 315, or monitor power drained from the battery 315 during operation of the mobile station 300. For instance, the battery charge monitor 320 can monitor an amount of power transferred from the battery 315. In another arrangement, the battery charge monitor 320 can monitor an amount of transmit power used by the transceiver 310 since the last battery re-charge, and subtracting the used transmit power used from a total available transmit power, which may be estimated based on a full battery charge. Nonetheless, the battery charge monitor 320 can monitor the effective charge level of the battery 315 in any other suitable manner and the invention is not limited in this regard.

The mobile station 300 further can include a datastore 325. The datastore 325 can include one or more storage devices, each of which can include a magnetic storage medium, an electronic storage medium, an optical storage medium, a magneto-optical storage medium, and/or any other storage medium suitable for storing digital information. In one arrangement, the datastore 325 can be integrated into the controller 305.

A battery charge communication application 330 can be contained on the datastore 325. The controller 305 can execute the battery charge communication application 330 and receive a signal from the battery charge monitor 320 that indicates the effective charge level of the battery 315, process such information, and generate the status information. The controller 305 then can communicate the status information to the transceiver 310, which can communicate such information to the network node or other communications network infrastructure.

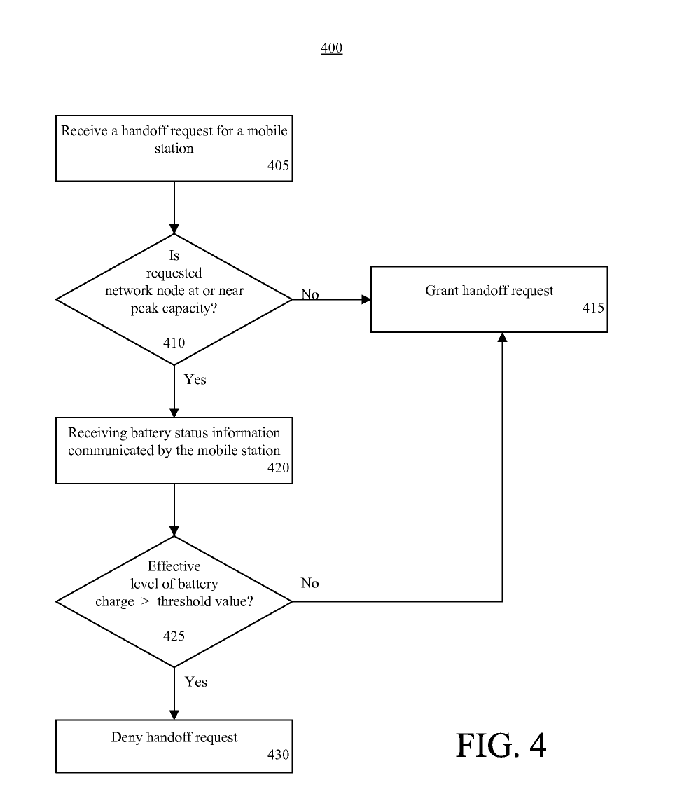

FIG. 4 is a flowchart presenting a method 400 that is useful for understanding the present invention. Beginning at step 405, a handoff request can be received for a mobile station. Referring to decision box 410, if the requested network node is not at or near peak capacity, at step 415 the handoff request can be granted. If, however, the network node is at or near peak capacity, at step 420 status information communicated by the mobile station can be received. Proceeding to decision box 425, if the effective level of battery charge on the mobile station is greater than a threshold value, at step 430 the handoff request can be denied. If, however, the effective level of battery charge on the mobile station is equal to or less than the threshold value, the process can proceed to step 415 and the handoff request can be granted.

The present invention can be realized in hardware, software, or a combination of hardware and software. The present invention can be realized in a centralized fashion in one processing system or in a distributed fashion where different elements are spread across several interconnected processing systems. Any kind of processing system or other apparatus adapted for carrying out the methods described herein is suited. A typical combination of hardware and software can be a processing system with an application that, when being loaded and executed, controls the processing system such that it carries out the methods described herein. The present invention also can be embedded in an application product, which comprises all the features enabling the implementation of the methods described herein, and which when loaded in a processing system is able to carry out these methods.

The terms “computer program,” “software,” “application,” variants and/or combinations thereof, in the present context, mean any expression, in any language, code or notation, of a set of instructions intended to cause a system having an information processing capability to perform a particular function either directly or after either or both of the following: a) conversion to another language, code or notation; b) reproduction in a different material form. For example, an application can include, but is not limited to, a subroutine, a function, a procedure, an object method, an object implementation, an executable application, an applet, a servlet, a source code, an object code, a shared library/dynamic load library and/or other sequence of instructions designed for execution on a processing system.

The terms “a” and “an,” as used herein, are defined as one or more than one. The term “plurality,” as used herein, is defined as two or more than two. The term “another,” as used herein, is defined as at least a second or more. The terms “including” and/or “having,” as used herein, are defined as comprising (i.e., open language).

This invention can be embodied in other forms without departing from the spirit or essential attributes thereof. Accordingly, reference should be made to the following claims, rather than to the foregoing specification, as indicating the scope of the invention.

What is claimed is:

1. A method for allocating handoff of mobile stations to a first network node, comprising:
receiving a handoff request for a first mobile station;
responsive to determining that the first mobile station has an effective level of battery charge equal to or below a threshold value, granting handoff to the first mobile station or, responsive to determining that the first mobile station has an effective level of battery charge greater than the threshold value, denying handoff of the first mobile station.

2. The method of claim 1, further comprising receiving status information communicated by the first mobile station.

3. The method of claim 2, wherein receiving the status information comprises receiving information that indicates an effective battery level of the first mobile station.

4. The method of claim 2, wherein receiving the status information comprises receiving information that indicates a handoff priority level of the first mobile station.

5. The method of claim 1, further comprising determining that the first network node is at or near peak capacity.

6. The method of claim 1, further comprising receiving status information communicated by a second mobile station.

7. The method of claim 6, wherein receiving the status information comprises receiving information that indicates an effective battery level of the second mobile station.

8. The method of claim 6, wherein receiving the status information comprises receiving information that indicates a handoff priority level of the second mobile station.

9. The method of claim 6, further comprising denying handoff of the second mobile station in response to the second mobile station having an effective level of battery charge greater than the threshold value.

10. The method of claim 6, further comprising handing off the second mobile station to a second network node in response to the second mobile station having an effective level of battery charge greater than the threshold value.

11. A machine readable storage, having stored thereon a computer program having a plurality of code sections comprising:
code for receiving a handoff request for a first mobile station;
code for granting handoff to the first mobile station in response to determining that the first mobile station has an effective level of battery charge equal to or below a threshold value; and
code for denying handoff of the first mobile station in response to determining that the first mobile station has an effective level of battery charge greater than the threshold value.

12. The machine readable storage of claim 11, further comprising code for receiving status information communicated by the first mobile station.

13. The machine readable storage of claim 12, wherein the code for receiving the status information comprises code for receiving information that indicates an effective battery level of the first mobile station.

14. The machine readable storage of claim 12, wherein the code for receiving the status information comprises code for receiving information that indicates a handoff priority level of the first mobile station.

15. The machine readable storage of claim 11, further comprising code for receiving status information communicated by a second mobile station.

16. The machine readable storage of claim 15, further comprising code for denying handoff of the second mobile station in response to the second mobile station having an effective level of battery charge greater than the threshold value.

17. The machine readable storage of claim 15, further comprising code for handing off the second mobile station to a second network node in response to the second mobile station having an effective level of battery charge greater than the threshold value.

18. A mobile station, comprising:
a transceiver;
a battery;
a battery charge monitor; and
a controller that receives a signal from the battery charge monitor that indicates an effective charge level of the battery, processes the signal to generate status information, and communicates the status information to the transceiver.

19. The mobile station of claim 18, wherein the transceiver transmits the status information to a node of a communications network.

20. The mobile station of claim 18, wherein the status information comprises a handoff priority level for the mobile station.
